(19) United States
(12) Patent Application Publication
(10) Pub. No.: US 2022/0315396 A1
(43) Pub. Date: Oct. 6, 2022

(54) PERIPHERY MONITORING DEVICE FOR WORK MACHINE

(71) Applicant: Sumitomo Heavy Industries Construction Cranes Co., Ltd., Tokyo (JP)

(72) Inventor: Tatsuya Matsushita, Aichi (JP)

(21) Appl. No.: 17/710,270

(22) Filed: Mar. 31, 2022

(30) Foreign Application Priority Data
Mar. 31, 2021 (JP) 2021-058961

(51) Int. Cl. B66C 23/88; B66C 13/18

(52) U.S. Cl. CPC B66C 23/88; B66C 13/18

(57) ABSTRACT

Provided is a periphery monitoring device for a work machine that displays an overhead image of the work machine and surroundings of the work machine, the device including: a detector that detects a distance to a surrounding object with respect to the work machine; and a display that displays the object in the overhead image with the distance between the work machine and the object reflected, in which a display range of the display for the object is a range obtained by extracting a portion of a detection range of the detector.

### RELATED APPLICATIONS

The content of Japanese Patent Application No. 2021-058961, on the basis of which priority benefits are claimed in an accompanying application data sheet, is in its entirety incorporated herein by reference.

### BACKGROUND

### Technical Field

Certain embodiments of the present invention relate to a periphery monitoring device for a work machine.

### Description of Related Art

A periphery monitoring device for a work machine in the related art performs line-of-sight conversion on images that are captured in a diagonally downward direction by cameras installed on all sides of the work machine, to obtain images viewed vertically from above, and combines the converted images to generate a so-called around view and a so-called overhead image, and displays the around view and the overhead image on a display unit (for example, refer to the related art).

### SUMMARY

According to an embodiment of the present invention, there is provided a periphery monitoring device for a work machine that displays an overhead image of the work machine and surroundings of the work machine, the device including: a detector that detects a distance to a surrounding object with respect to the work machine; and a display that displays the object in the overhead image with the distance between the work machine and the object reflected, in which a display range of the display for the object is a range obtained by extracting a portion of a detection range of the detector.

### BRIEF DESCRIPTION OF THE DRAWINGS

FIG. 1 is a side view of a crane in which a periphery monitoring device according to an embodiment of the present invention is mounted.

FIG. 2 is a block diagram illustrating a configuration of a control device for the crane and peripherals of the control device.

FIG. 3 is a display example of a detection image in which a detection result is displayed on a display unit when a surrounding object within a three-dimensional detection range is detected by a periphery detection device.

FIG. 4 is a right side view of a rear portion of the crane illustrating one example of the display range.

FIG. 5 is a display example of a detection image in which only objects detected within the display range are displayed on the display unit.

FIG. 6 is a display example of a detection image displaying only objects detected within the display range when height limitation and distance limitation are performed.

FIG. 7 is a display example of a detection image when a display range having a rectangular shape in a plan view is set.

FIG. 8 is a display example when an alarm range is displayed on the display unit.

FIG. 9 is a flowchart of a periphery monitoring process.

FIG. 10A is a display example of an icon of a picture in which a portion corresponding to a lower traveling body of the crane is omitted, and FIG. 10B is a display example of an icon of a picture in which a portion corresponding to a boom is omitted in addition to the omission of the lower traveling body of the crane.

### DETAILED DESCRIPTION

However, since image distortion is generated in the images on which line-of-sight conversion is performed, it may be difficult to identify a correct distance to a surrounding object from the overhead image displayed by the periphery monitoring device of the related art.

It is desirable to perform display such that a distance to an object around a work machine can be more correctly identified.

Schematic Configuration of Crane

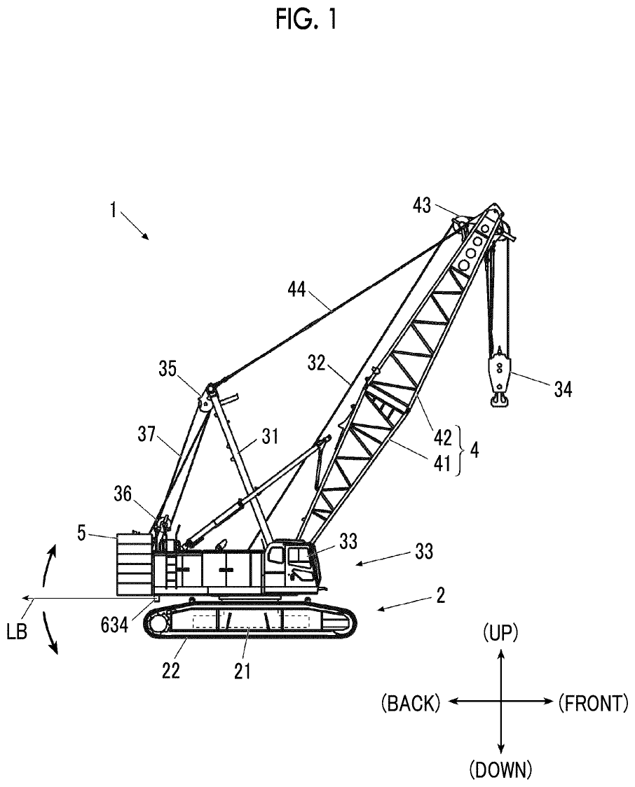

FIG. 1 is a side view of a crane as a work machine in which a periphery monitoring device according to an embodiment of the present invention is mounted.

A crane 1 is a so-called mobile crawler crane. In the description of the crane 1, a front-back direction and a left-right direction seen from an occupant of a rotating platform 3 will be described as a front-back direction and a left-right direction of the crane 1. Incidentally, unless otherwise specified, in principle, the front, back, left, and right of the crane 1 will be described in a state where a lower traveling body 2 and the rotating platform 3 are aligned with each other in the front-back direction (referred to as a reference posture). In addition, an up-down direction of the crane 1 in a state where the crane 1 is placed on a horizontal plane may be referred to as a vertical direction.

As illustrated in FIG. 1, the crane 1 is configured to include the lower traveling body 2 of a crawler type that can travel automatically, the rotating platform 3 that is turnably mounted on the lower traveling body 2, and a boom 4 that is derrickably attached to a front side of the rotating platform 3.

The lower traveling body 2 includes a main body 21 and crawlers 22 provided on both left and right sides of the main body 21. The left and right crawlers 22 each are rotationally driven by traveling hydraulic motors (not illustrated).

A lower end portion of the boom 4 is supported on the front side of the rotating platform 3. In addition, a lower end portion of a mast 31 is supported on the rotating platform 3 in a position behind a boom support position.

In addition, the rotating platform 3 is driven and turned around an axis along the vertical direction with respect to the lower traveling body 2 by a turning hydraulic motor (not illustrated).

A counterweight 5 that balances the weights of the boom 4 and a suspended load is attached to a rear portion of the rotating platform 3. The number of the counterweights 5 can be increased or reduced as needed.

A derricking winch (not illustrated) that performs a derricking operation of the boom 4 is disposed in front of the counterweight 5, and a hoisting winch (not illustrated) that winds and unwinds a hoisting rope 32 is disposed in front of the derricking winch. The hoisting winch is driven by a hoisting hydraulic motor (not illustrated) to wind and unwind the hoisting rope 32, thereby raising and lowering a hook 34 and the suspended load.

In addition, a cab 33 is disposed on a right front side of the rotating platform 3.

The boom 4 is derrickably attached to the rotating platform 3. The boom 4 includes a lower boom 41 and an upper boom 42.

A sheave 43 that guides the hoisting rope 32 is rotatably attached to an upper end portion of the upper boom 42.

The mast 31 includes an upper spreader 35 at an upper end portion of the mast 31, and the upper spreader 35 is connected to the other end portion of a pendant rope 44 of which one end portion is connected to an upper end portion of the boom 4. A lower spreader 36 is provided below the upper spreader 35, and when a derricking rope 37 that is hung between the lower spreader 36 and the upper spreader 35 a plurality of times is wound or unwound by the derricking winch, the interval between the upper spreader 35 and the lower spreader 36 is changed, and the boom 4 is derricked. The derricking winch of the boom is driven by a derricking hydraulic motor (not illustrated).

### Control System for Crane

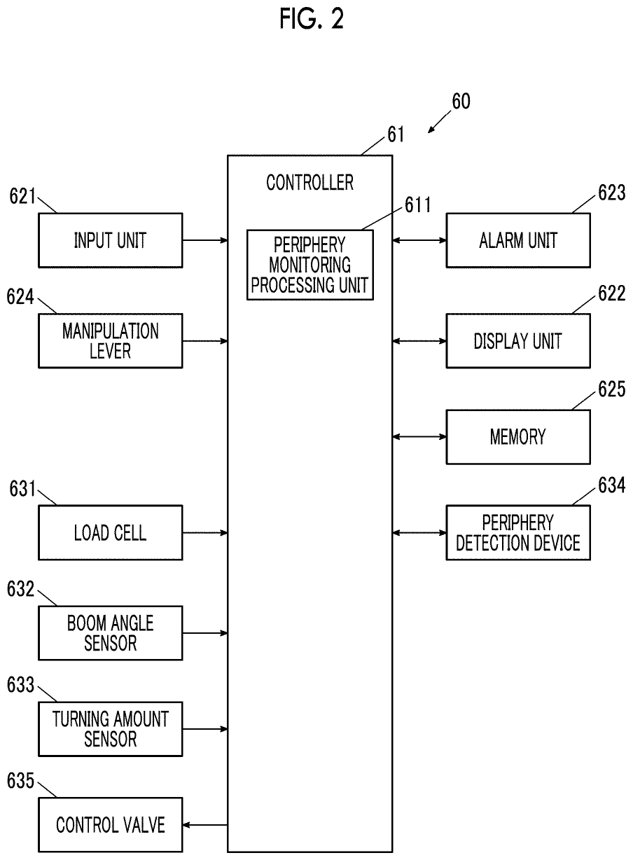

A control device 60 for the crane is provided in the cab 33 of the rotating platform 3. FIG. 2 is a block diagram illustrating a configuration of the control device 60 and peripherals of the control device 60. The control device 60 is a control terminal mounted in the crane 1, and mainly performs a periphery monitoring process of the crane 1 in addition to controlling traveling and turning of the crane 1 and various operations of the suspended load and the like.

The control device 60 includes a controller 61 configured to include a calculation processing device including a CPU, a ROM and a RAM that are storage devices, other peripheral circuits, and the like.

The controller 61 includes a software module such as a periphery monitoring processing unit 611 that performs the periphery monitoring process. Incidentally, the periphery monitoring processing unit 611 may be configured as hardware.

The controller 61 (periphery monitoring processing unit 611), an input unit 621, and a display unit 622 function as a periphery monitoring device that displays an overhead image of the crane 1 and surroundings of the crane 1. A function of the periphery monitoring device will be described later.

The input unit 621, the display unit 622 as a display, an alarm unit 623, a manipulation lever 624, and a memory 625 are connected to the controller 61, and these components form the control device 60.

Further, a load cell 631, a boom angle sensor 632, a turning amount sensor 633, a periphery detection device 634 as a detector, and a control valve 635 are connected to the controller 61.

The input unit 621 is provided in the cab 33, is, for example, an input interface such as a touch panel, and outputs a control signal corresponding to a manipulation from a worker to the controller 61. The worker can manipulate the input unit 621 to input a length of the boom 4, a weight of the suspended load, various other settings, or various information required for operation.

The display unit 622 is provided in the cab 33, includes, for example, a touch panel type display that is also used as the input unit 621, and displays information such as the weight of the suspended load, a boom angle, and a turning angle of the rotating platform 3 on a display screen based on a control signal output from the controller 61.

The alarm unit 623 generates an alarm based on a control signal output from the controller 61.

The manipulation lever 624 is provided in the cab 33, for example, manually inputs a manipulation to cause the crane 1 to perform various operations, and inputs a control signal corresponding to a manipulated variable of the manipulation lever 624 to the controller 61.

For example, the manipulation lever 624 can input a manipulation for a traveling operation of the lower traveling body 2, a turning operation of the rotating platform 3, a derricking operation of the boom 4, or winding and unwinding of the hoisting rope 32 by the hoisting winch.

The load cell 631 is attached to the upper spreader 35, and detects a tension acting on the pendant rope 44 that derricks the boom 4, to output a control signal corresponding to the detected tension to the controller 61.

The boom angle sensor 632 is attached to a base end side of the boom 4, and detects a derricking angle of the boom 4 (hereinafter, also referred to as a boom angle) to output a control signal corresponding to the detected boom angle to the controller 61. The boom angle sensor 632 detects, for example, a ground angle that is an angle with respect to a horizontal plane, as a boom angle.

The turning amount sensor 633 is attached between the lower traveling body 2 and the rotating platform 3, and detects a turning angle of the rotating platform 3 to output a control signal corresponding to the detected turning angle to the controller 61. The turning amount sensor 633 detects, for example, an angle around a vertical axis as a turning angle.

The control valve 635 includes a plurality of valves that can be switched according to a control signal from the controller 61.

For example, the control valve 635 includes a valve that controls the rotational drive of the left and right crawlers 22 of the lower traveling body 2, a valve that controls a turning operation of the rotating platform 3, a valve that controls the rotational drive of the derricking winch, a valve that controls the rotational drive of the hoisting winch, and the like.

### Periphery Detection Device

The periphery detection device 634 is a distance measurement device using a sensor that detects a distance to an object existing around the crane 1, for example, a laser scanner such as a light detection and ranging (LiDAR). Incidentally, the “object” to which a distance is to be detected includes not only things but also persons.

As illustrated in FIG. 1, the periphery detection device 634 is attached to a bottom surface of a rear end portion of the rotating platform 3 (rear end portion in a state where the counterweight 5 is not provided).

The periphery detection device 634 has a fan-shaped horizontal two-dimensional plane as one of detection planes, the two-dimensional plane extending in a horizontal direction of the crane 1 within a range of 135° (270° in total) from a straight line LB of a length of approximately 25 m extending horizontally rearward to each of both left and right sides of the periphery detection device 634 as a center. Further, the periphery detection device 634 has a three-dimensional range as a detection range, the three-dimensional range being obtained by inclining the fan-shaped detection plane upward and downward within a range of an angle of 90 degrees or less around a horizontal axis passing through the periphery detection device 634 in the left-right direction. Namely, the periphery detection device 634 performs distance detection within the three-dimensional range by scanning the two-dimensional plane with laser light within a range of 135° from the straight line LB to both the left and right sides, and by performing scanning on the two-dimensional plane upward and downward around the horizontal axis within a range of an angle of 90 degrees or less while changing the angle in a very small amount.

As described above, since the periphery detection device 634 detects a distance to an object in all around directions, the periphery monitoring processing unit 611 can generate data of a detection image in which a direction and a distance with respect to the periphery detection device 634 are associated with each other, from the detection result.

However, since the periphery detection device 634 uses irradiation with laser light, the periphery detection device 634 cannot detect an object within a range shielded by each part of the crane 1.

Incidentally, regarding the periphery detection device 634, the length of the straight line LB and the angle ranges in the left-right direction and in the up-down direction where detection is performed are one example, and are not limited to the above numerical values.

In addition, the periphery detection device 634 may perform detection by rotating a detection plane parallel to a vertical direction of the crane 1, leftward and rightward around the vertical axis.

Further, the periphery detection devices 634 may be provided in any position on a vehicle body, for example, at a plurality of locations such as a left end, a right end, a front end, and the like of the rotating platform 3.

Incidentally, the “horizontal direction” of the crane 1 indicates a direction along a plane perpendicular to a turning axis of the rotating platform 3, and is a direction parallel to the front-back direction and to the left-right direction described above.

In addition, the “vertical direction” of the crane 1 indicates a direction parallel to the turning axis of the rotating platform 3, and is a direction parallel to the up-down direction described above.

### Detection Image of Periphery Detection Device

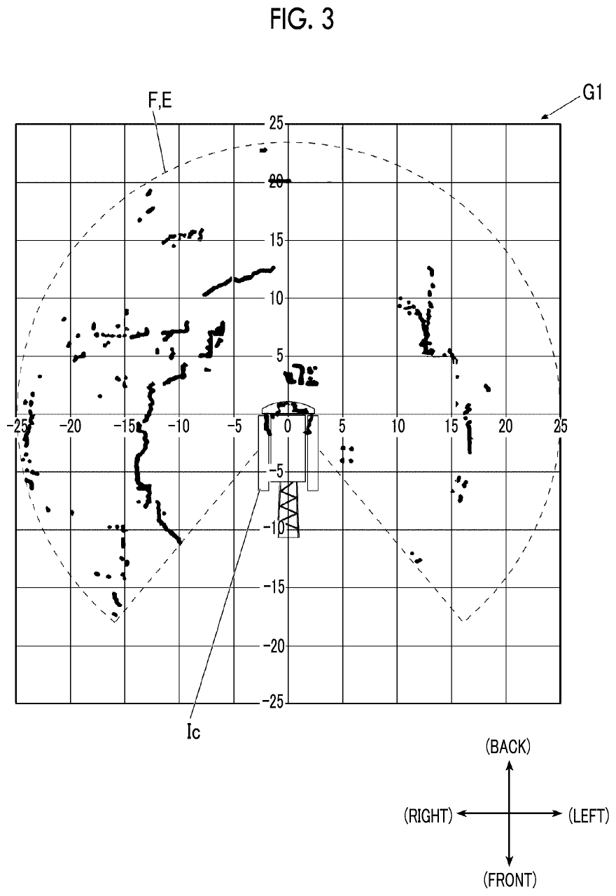

FIG. 3 illustrates a display example of a detection image (overhead image) G1 when a surrounding object is detected within the three-dimensional detection range by the periphery detection device 634 and is displayed on the display unit 622 with a distance as a detection result reflected.

In addition, the expression “display is performed . . . with the distance reflected” means that the object is displayed at a distance obtained by multiplying the distance detected by the periphery detection device 634 by a predetermined magnification. In addition, a case where it is said that “display is performed . . . with the distance reflected” includes a case where displaying is performed with a magnification of only a specific region changed, and a case where the object is displayed at a distance obtained by multiplication of a uniform magnification without changing the magnification.

In the case of a setting for unlimitedly displaying the entirety of the detection range of the periphery detection device 634, the periphery monitoring processing unit 611 displays a detection image on the display unit 622, the detection image being obtained by projecting all surrounding objects detected within the three-dimensional detection range by the periphery detection device 634, on a horizontal plane via orthography. In addition, in the case of setting a display range to be described later, the display unit 622 displays a detection image obtained by projecting all surrounding objects detected within the display range, on a horizontal plane via orthography.

In addition, the periphery monitoring processing unit 611 displays an object on a detection image at a distance obtained by multiplying the distance detected by the periphery detection device 634 by the same magnification as a display magnification of the detection image.

For example, when a detection image displays a range of 25 m in height and width in 5 cm in height and width, an object in an X, Y position at a distance (X, Y, Z) detected by the periphery detection device 634 is displayed on the detection image in a position at a distance with a magnification multiplied by 5/2500.

Incidentally, the detection image G1 is an image in which a dot indicating each point on an object detected by the periphery detection device 634 is displayed in the screen in a predetermined position corresponding to a detection direction and to a detection distance, according to a direction and a distance at each point on a surface of the object. For example, when a plurality of consecutive points are detected on a surface of an object, the dots in a detection image are continuously displayed to trace an outer shape of the object.

In addition, in the detection image G1 displayed on the display unit 622 by the periphery detection device 634, an icon Ic representing the crane 1 in a plan view is displayed at a scale and in a direction corresponding to a scale of the detection image and to a detection direction of the periphery detection device 634.

### Display of Detection Image Based on Display Range by Periphery Monitoring Processing Unit

As illustrated in FIG. 3, when the setting is such that results of detection within the entirety of the detection range by the periphery detection device 634 are unlimitedly displayed, an object or unevenness of the ground existing at a height that hardly affects operation of the crane 1 and a portion or the like of the vehicle body of the crane 1 existing within the detection range of the periphery detection device 634 are displayed, and it can be difficult to distinguish those things from an obstacle that can normally affect operation of the crane 1.

Therefore, the periphery monitoring processing unit 611 performs control to display only objects on the display unit 622, the objects being detected within a display range that is included in the entirety of the detection range of the periphery detection device 634 and that is narrower than the detection range.

The display range can be arbitrarily set, for example, from the input unit 621.

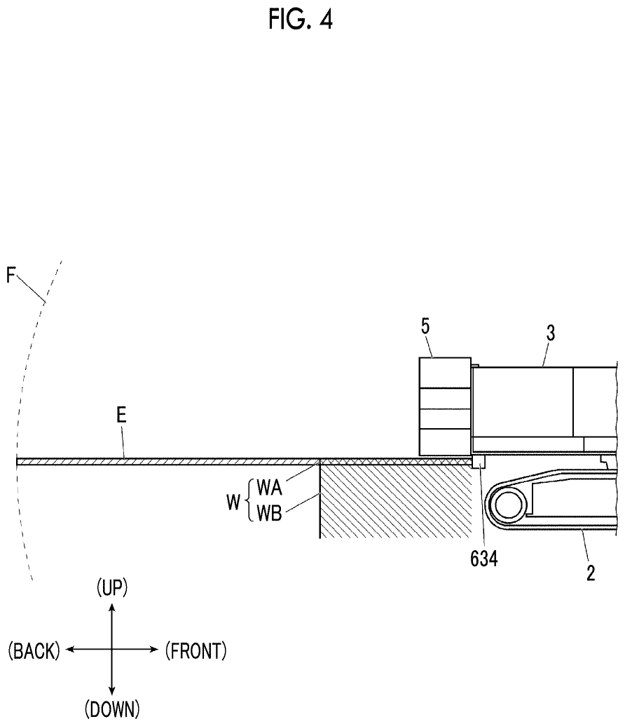

FIG. 4 is a right side view of a rear portion of the crane 1 illustrating one example of the display range. In FIG. 4, a display range E obtained by performing height limitation on the entirety of a detection range F of the periphery detection device 634 is provided as an example. More specifically, as an example, a case is provided in which the display range E in FIG. 4 is set in only a plane at the height of the bottom surface of the rotating platform 3 and along the horizontal direction of the crane 1, with respect to the entirety of the detection range F of the periphery detection device 634.

Incidentally, the display range E is the range of a fan-shaped horizontal two-dimensional plane extending within a range of 135° (270° in total) from the straight line LB in FIG. 1 to each of both the left and right sides of the periphery detection device 634 as a center. For this reason, the display range E extends to the front of the periphery detection device 634 (portion in front of a zero point on a vertical axis in FIG. 3), but in FIG. 4, a range in front of the periphery detection device 634 is omitted.

Incidentally, as illustrated in FIG. 3, the detection range F and the display range E lack a range of 90° in a plan view on a front side of the crane 1, and the detection range F and the display range E are smaller on the front side of the crane 1 than on a rear side thereof. The reason is that the need for detecting an object is low since a range of 90° on the front side of the crane 1 is a range where the visibility from the cab 33 is good.

However, it goes without saying that the periphery detection device 634 may be provided at a front end of the vehicle body to also perform detection and display for a range of 90° on the front side of the crane 1.

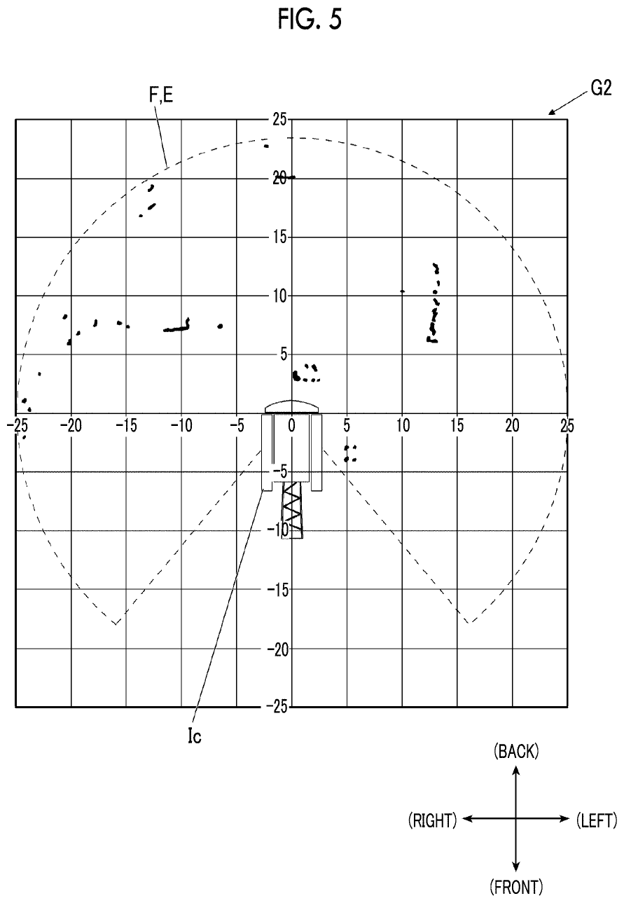

FIG. 5 illustrates a display example of a detection image (overhead image) G2 when only objects detected within the display range E in FIG. 4 are displayed on the display unit 622.

As compared to FIG. 3, in the detection image G2 in FIG. 5, objects corresponding to an object or unevenness of the ground existing at a height that does not affect operation of the crane 1, and to a portion or the like of the vehicle body of the crane 1 existing within the detection range of the periphery detection device 634 are all not displayed, and only an object in the vicinity of the height of the bottom surface of the rotating platform 3 which is likely to affect operation of the crane 1 is displayed.

Therefore, it is possible to easily recognize an obstacle that can affect operation of the crane 1, with the detection image G2.

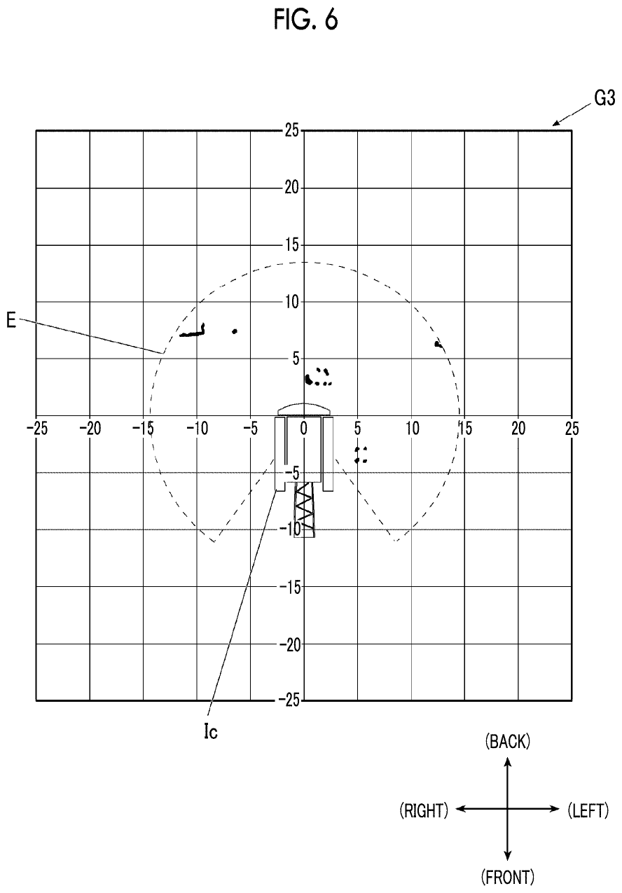

In addition, it is possible to perform not only height limitation but also distance limitation on the entirety of the detection range of the periphery detection device 634. FIG. 6 illustrates a display example of a detection image (overhead image) G3 when height limitation and distance limitation are performed on the entirety of the detection range of the periphery detection device 634 and only objects detected within the display range E are displayed on the display unit 622. As an example, a case is provided in which the display range of the detection image G3 is limited to approximately a half the detection range of the periphery detection device 634.

For example, when the display range E of the detection image G2 extends to a distance that cannot affect operation of the crane 1, as in the detection image G3, extra information outside the display range E on which distance limitation is performed is not displayed by limiting the display range E to a distance that can affect operation of the crane 1, so that it is possible to more clearly recognize an obstacle that can affect operation of the crane 1.

In addition, the case of performing distance limitation on the entire of the detection range F of the periphery detection device 634 is not limited to the case of setting the display range E having a circular shape in a plan view and having a uniform distance in all directions around the periphery detection device 634.

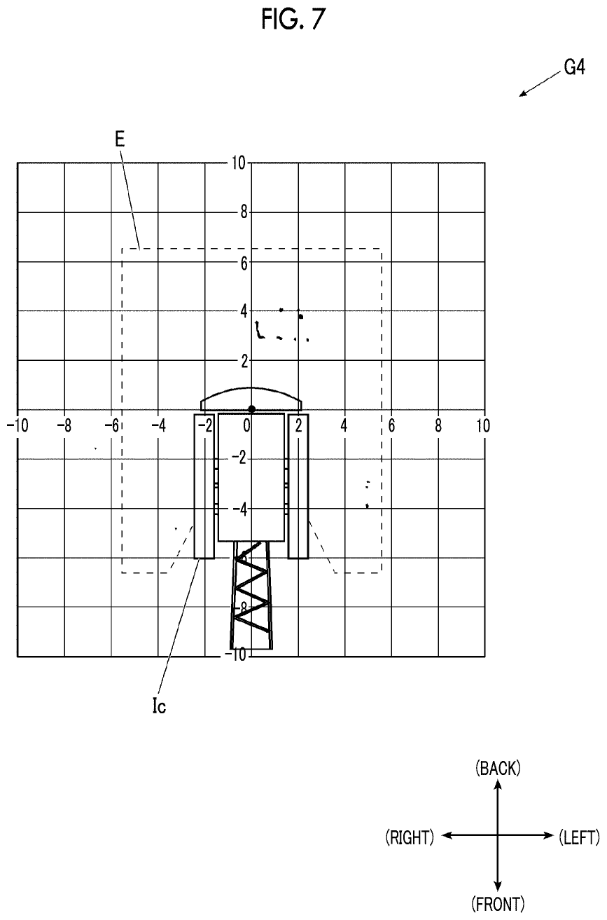

For example, the display range E having any shape in a plan view on which distance limitation is performed may be set by setting a limit distance individually for each direction around the periphery detection device 634. For example, FIG. 7 illustrates a detection image G4 when the display range E having a rectangular shape in a plan view is set.

Accordingly, for example, it is possible to display an object detected for the display range E more appropriately corresponding to a scheduled operation of the crane 1 or to a planar shape of the crane 1, and it is possible to further clearly recognize an object that can be an obstacle.

### Alarm Control Based on Alarm Range by Periphery Monitoring Processing Unit

When the periphery detection device 634 detects an object within an alarm range W that is included in the entirety of the detection range F and that is narrower than the detection range F, the periphery monitoring processing unit 611 executes alarm control to alarm a worker that operates the crane 1, in a mode different from display of an object within the display range E, for example, by displaying the alarm range W in a highlighted manner, such as displaying in color. Here, the periphery monitoring processing unit 611 that executes alarm control to alarm the worker by displaying the alarm range W in a highlighted manner, such as displaying in color, functions as an “alarm”.

The alarm range W can be arbitrarily set, for example, from the input unit 621.

As an example, the alarm range W is provided which is obtained by performing height limitation and distance limitation on the entirety of the detection range F of the periphery detection device 634 as illustrated in FIG. 4 above. As an example, a case is provided in which the alarm range W is narrower than the display range E in the horizontal direction, and wider than the display range E in the vertical direction, as compared to the display range E illustrated in FIG. 4. In the alarm range W, a range overlapping the display range E is referred to as an overlapping region WA, and a range extended from the display range E in the vertical direction is referred to as an extended region WB.

More specifically, as an example, a case is provided in which the alarm range W in FIG. 4 is closer in distance to the periphery detection device 634 in the horizontal direction than the display range E, and includes the entirety of a range equal to or less than the height of the bottom surface of the rotating platform 3 in the vertical direction.

Incidentally, the alarm range W in a side view also extends to the front of the periphery detection device 634 to some extent, but similarly to the illustration of the display range E, in FIG. 4, the illustration of a range in front of the periphery detection device 634 (portion in front of the zero point on the vertical axis in FIG. 3) is omitted.

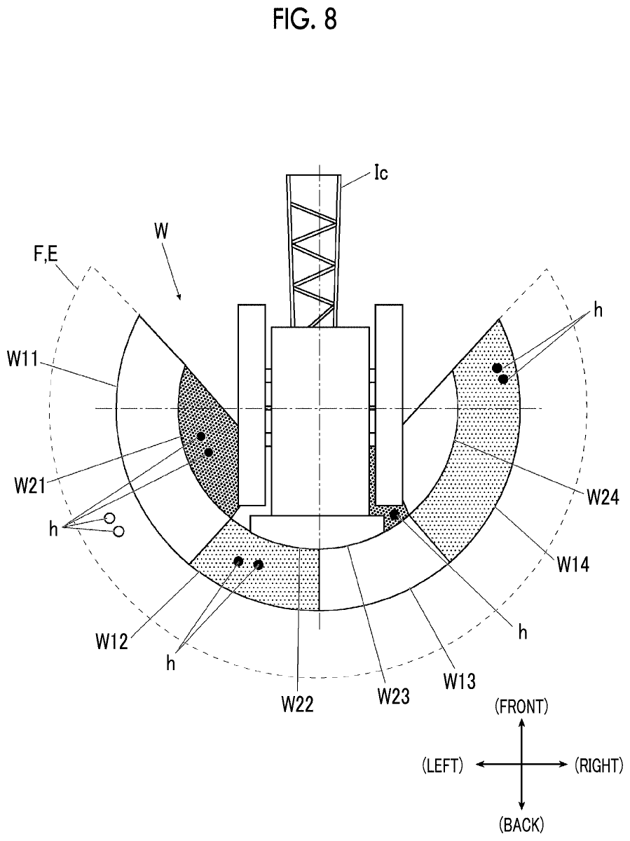

FIG. 8 is a display example when the alarm range W is displayed in more detail on the display unit 622.

As illustrated, the alarm range W may be set in a stepwise manner according to the distance from the crane 1.

For example, in the alarm range W, ranges that are separated in distance from the crane 1 may be set as caution ranges W11 to W14, and ranges that are closer in distance to the crane 1 may be set as warning range W21 to W24.

The caution ranges W11 to W14 indicate, for example, ranges within a distance which calls attention of the worker, and the warning range W21 to W24 indicate, for example, ranges within a distance where any action should be taken for the worker.

Further, as with the caution ranges W11 to W14 and the warning range W21 to W24, the alarm range W may be individually divided in a plurality of directions around the crane 1. FIG. 8 illustrates four divisions as an example, but the number of divisions can be arbitrarily changed.

As described above, when an object is detected within the alarm range W, the periphery detection device 634 executes alarm control to alarm the worker that operates the crane 1.

As described above, when the alarm range W is divided into a plurality of ranges, for example, the periphery detection device 634 may execute alarm control to display a range where the object is detected, among the caution ranges W11 to W14 and the warning range W21 to W24 in a highlighted manner, such as adding a color, increasing the brightness, or performing displaying in a blinking manner.

In that case, as illustrated in FIG. 8, when an object h is detected in each range, it is preferable that the warning range W21 to W24 that are closer in distance to the crane 1 are displayed in a more highlighted manner than the caution ranges W11 to W14 that are separated in distance from the crane 1. The highlighted display includes, for example, display in a darker color, display in a brighter color, display in which the blinking speed of the corresponding range is increased, and the like.

In addition, as with the caution ranges W11 to W14 and the warning range W21 to W24, when the alarm range W is individually divided in a plurality of directions around the crane 1, it is possible to clearly and quickly recognize in which direction the object h exists.

### Flow of Periphery Monitoring Process by Crane

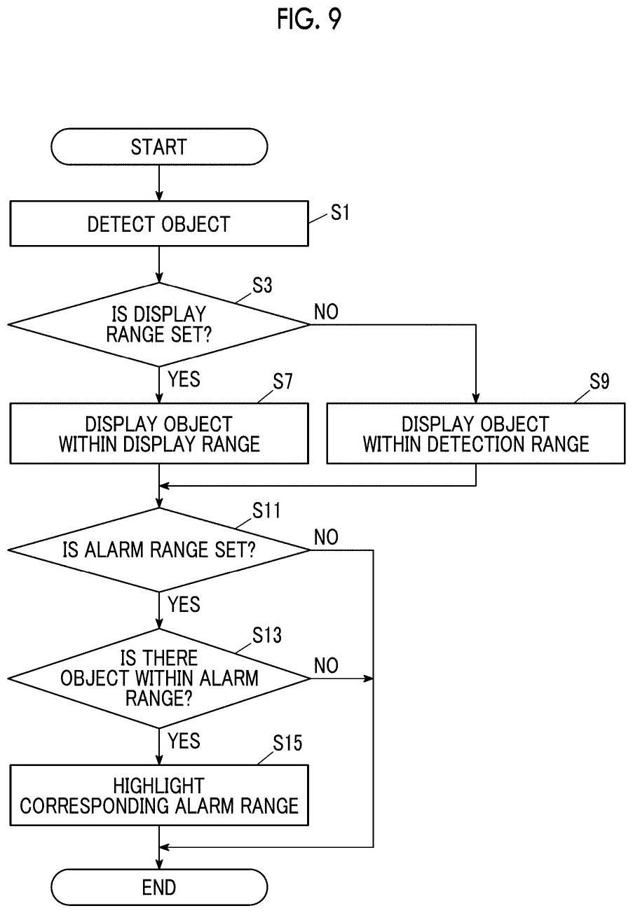

FIG. 9 is a flowchart illustrating the periphery monitoring process performed by the periphery monitoring processing unit 611 of the controller 61 for the crane 1.

First, the periphery monitoring processing unit 611 causes the periphery detection device 634 to execute object detection within the detection range F (step S1).

Then, it is determined whether or not the display range E extracted from the detection range F is set (step S3).

As a result, when the display range E is not set, the periphery monitoring processing unit 611 displays a detection image on the display unit 622 based on a result of detection within the entirety of the detection range F (step S5).

In addition, when the display range E is set, the periphery monitoring processing unit 611 displays a detection image on the display unit 622 based on a result of detection within the display range E (step S7).

After the detection image is displayed, the periphery monitoring processing unit 611 determines whether or not the alarm range W extracted from the detection range F is set (step S11).

Then, when the alarm range W is not set, the process ends.

In addition, when the alarm range W is set, the periphery monitoring processing unit 611 determines whether or not an object is detected within the alarm range W (step S13).

Then, when no object is detected within the alarm range W, the process ends.

In addition, when an object is detected within the alarm range W, the periphery monitoring processing unit 611 controls the display unit 622 to display the alarm range W in a highlighted manner.

In this case, when the alarm range W is divided into a plurality of ranges as with the caution ranges W11 to W14 and the warning range W21 to W24, a range where an object is detected is specified, and the display unit 622 is controlled to display the range in a highlighted manner determined in advance.

Then, the process ends.

### Technical Effects of Embodiment of Invention

As described above, since the periphery monitoring processing unit 611 of the controller 61 for the crane 1 displays a detection image in which an object is displayed with a distance to the object reflected, on the display unit 622, the distance being detected by the periphery detection device 634 to detect distances to objects around the crane 1, line-of-sight conversion processing of the captured image is not required, and it is possible to display the detection image by which the distance to the object can be more correctly identified.

Further, since the periphery monitoring processing unit 611 sets the display range E of the display unit 622 for an object to a range obtained by extracting a portion of the detection range F of the periphery detection device 634, and displays a detection image, it is possible to suppress display including a result of detection within a range having low importance with respect to the crane 1, and it is possible to cause the worker to appropriately and clearly recognize surrounding objects.

In addition, in a detection image, since an object is displayed at a distance obtained by multiplying a distance detected by the periphery detection device 634 by the same magnification as a display magnification of the detection image, it is easy to sensibly recognize the distance.

In addition, when an object enters the alarm range W set in advance, the periphery monitoring processing unit 611 issues an alarm in a mode different from display of an object within the display range E, it is possible to call special attention of the worker to the entering of the object into the alarm range W.

In addition, the periphery monitoring processing unit 611 sets the alarm range W based on a distance to an object with respect to the crane 1, and divides the alarm range W into a plurality of ranges to set the plurality of ranges, as with the caution ranges W11 to W14 and the warning range W21 to W24.

Further, when the object h enters any region of the caution ranges W11 to W14 or of the warning range W21 to W24, the periphery monitoring processing unit 611 causes the display unit 622 to display the region in a highlighted manner.

Therefore, as with the caution ranges W11 to W14 and the warning range W21 to W24, when the alarm range is divided into ranges where the distances to objects with respect to the crane 1 are different from each other, it is possible to cause the worker to clearly recognize at which distance an object exist.

In addition, as with the caution ranges W11 to W14 or the warning range W21 to W24, when the alarm range is divided into a plurality of ranges according to the direction with respect to the crane 1, it is possible to cause the worker to clearly recognize in which direction an object exists.

In addition, when the periphery monitoring processing unit 611 sets the display range E to the alarm range W or larger in the horizontal direction of the crane 1, the existence of an object on low alert outside the alarm range W can be recognized in advance. In addition, it is possible to take action against the approach of an object in an earlier stage.

In addition, the periphery monitoring processing unit 611 sets the alarm range W not only to the overlapping region overlapping the display range E but also to the extended region where the alarm range W is the display range E or larger in the vertical direction of the crane 1, so that it is possible to perform recognition while reducing height limitation to or eliminating limitation to the alarm range W on high alert.

In addition, since the periphery monitoring processing unit 611 does not display an object within a range of the alarm range W, which is equal to or larger than the display range E, it is possible to respond to a request to display an object only within the display range that is a range to be desired to be displayed, while issuing an alarm.

In addition, when the periphery monitoring processing unit 611 sets the display range E to a range that is smaller on the front side of the crane 1 than on the rear side thereof, it is possible to omit display of an object for a range where the visibility is good, and it is possible to optimize the range of recognition of an object by the display unit 622.

### Others

The detailed parts described in the embodiment of the invention can be appropriately changed without departing from the concept of the invention.

For example, a case has been provided in which the icon Ic for the crane 1 described above is illustrated as being a picture in which the entirety of the crane 1 is viewed overhead described above, but the present invention is not limited thereto.

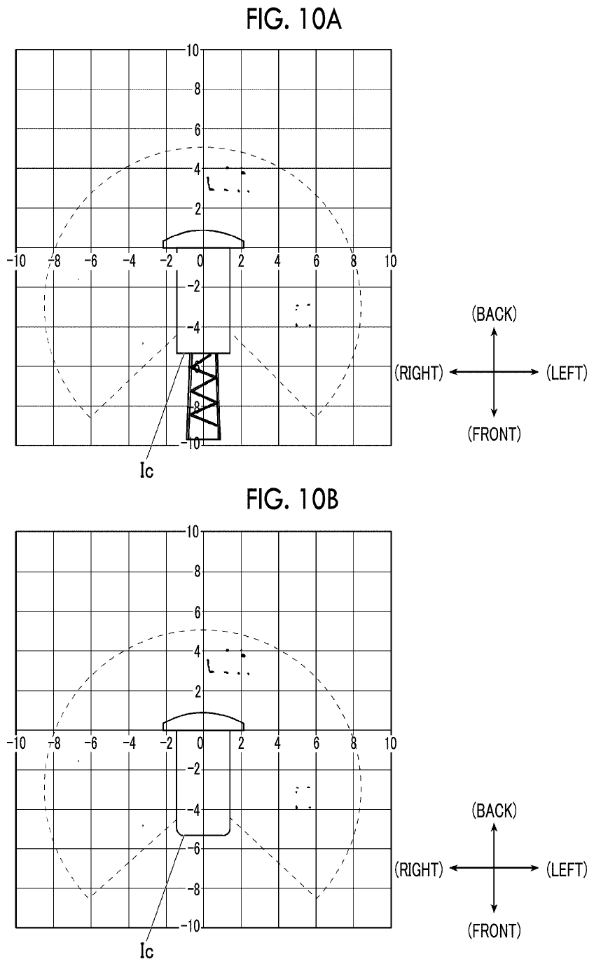

For example, as with the icon Ic illustrated in FIG. 10A, a picture may be illustrated in which a portion corresponding to the lower traveling body 2 (crawlers 22) of the crane 1 is omitted. Further, as with the icon Ic illustrated in FIG. 10B, a picture may be illustrated in which a portion corresponding to the boom 4 is omitted, in addition to the omission of the lower traveling body 2 of the crane 1.

In this case, each of the above icons Ic may be selectively useable.

Regarding the icon Ic illustrated in FIG. 10A or FIG. 10B, for example, as described above, when a range on a horizontal plane at the height of the periphery detection device 634 is set as the display range E, the icon Ic is displayed which excludes configurations of the crane 1 that are unlikely to cause interference at the height of an object to be displayed, so that it is possible to clearly recognize a distance between an object and the crane 1 that can cause interference.

In addition, in the case of being able to remove the crawlers 22 or the boom 4 from the crane 1, when the crane 1 is used with the crawlers 22 or the boom 4 removed, it is possible to use an appropriate icon Ic according to the state of the crane 1, and it is possible to appropriately recognize a distance to an object.

In addition, the configuration of the crane 1 in which the periphery monitoring device is implemented is not limited to the crawler crane, and is applicable to any crane including a winch drum, such as a port crane, an overhead crane, a jib crane, a portal crane, an unloader, or a fixed crane, in addition to other mobile cranes such as a wheel crane and a truck crane.

Further, the periphery monitoring device is also applicable to work machines such as a hydraulic excavator and a foundation machine other than the crane.

In addition, the periphery detection device 634 is not limited to the laser scanner, and a distance detector using a camera, ultrasonic waves, or the like can be used as long as the distance detector can detect a distance to an object.

In addition, the entirety of a detection image including an object is displayed at a constant scale magnification, but the detection image may be displayed with the magnification of a part of a range changed.

In addition, in the embodiment, an example has been illustrated in which a detection image (overhead image) is displayed on the display unit 622 provided in the crane 1, but the detection image (overhead image) may be displayed on a mobile terminal or on a display unit seen by a manager outside the crane.

In addition, in the embodiment, an example has been illustrated in which the alarm (periphery monitoring processing unit 611) colors the alarm range W of a detection image to alarm the worker, but it is possible to use any alarm for calling attention, such as alarm by sound, display on another screen other than the detection image, vibration, or automatic stop of the crane. In addition, as an alarm, for example, an image of an object in an alarm range may be captured by another camera, and displayed.

In addition, a target to which an alarm is issued is also not limited to the worker (occupant) of the crane 1, and may be a manager outside the crane 1, a surrounding on-site worker, or the like.

In the embodiment, as an example, a case has been provided in which the alarm range is narrower than the display range in the horizontal direction and wider than the display range in the vertical direction, but the present invention is not limited thereto, and another pattern may be used in which the alarm range and the display range are differently set in the horizontal direction and in the vertical direction. For example, the alarm range may be wider than the display range in both the horizontal direction and the vertical direction, or may be narrower than the display range in both directions, or the alarm range may be wider than the display range in the horizontal direction, and narrower than the display range in the vertical direction.

In addition, the display range E and the alarm range W may be set not to overlap each other at all.

Since processing to be executed when an object exists differs between the alarm range and the display range, it is possible to respond to various requests with the above various patterns.

In addition, the display range E may be set to a range where the height in the vertical direction varies depending on the distance from the crane 1 in the horizontal direction (periphery detection device 634). For example, as one example, the display range E and the alarm range W illustrated in FIG. 4 may form a whole display range. In this case, the display range E may include the entirety of the alarm range W.

In addition, the display range E may be set to a range where the height in the vertical direction increases as the distance from the work machine in the horizontal direction decreases. In this case, as in the case where the display range E and the alarm range W illustrated in FIG. 4 forma whole display range, the display range may have a stepwise shape, and may be set to range where the height in the vertical direction gradually increases as the distance from the work machine in the horizontal direction decreases.

It should be understood that the invention is not limited to the above-described embodiment, but may be modified into various forms on the basis of the spirit of the invention. Additionally, the modifications are included in the scope of the invention.

What is claimed is:

1. A periphery monitoring device for a work machine that displays an overhead image of the work machine and surroundings of the work machine, the device comprising:
a detector that detects a distance to a surrounding object with respect to the work machine; and
a display that displays the object in the overhead image with the distance between the work machine and the object reflected,
wherein a display range of the display for the object is a range obtained by extracting a portion of a detection range of the detector.

2. The periphery monitoring device for a work machine according to claim 1,
wherein in the overhead image, the object is displayed at a distance obtained by multiplying the distance detected by the detector by the same magnification as a display magnification of the overhead image.

3. The periphery monitoring device for a work machine according to claim 1, further comprising:
an alarm that issues an alarm in a mode different from display of the object within the display range, when the object enters an alarm range set in advance.

4. The periphery monitoring device for a work machine according to claim 3,
wherein the alarm range includes an overlapping region included in the display range, and an extended region extended from the display range in a vertical direction.

5. The periphery monitoring device for a work machine according to claim 1,
wherein a height of the display range in a vertical direction varies depending on a distance from the work machine in a horizontal direction.

6. The periphery monitoring device for a work machine according to claim 5,
wherein the height of the display range in the vertical direction increases as the distance from the work machine in the horizontal direction decreases.

7. The periphery monitoring device for a work machine according to claim 3,
wherein the alarm range is divided into a plurality of regions and set, and
when the object enters any region of the alarm range, the alarm causes the display to display the region in a highlighted manner.

8. The periphery monitoring device for a work machine according to claim 7,
wherein in the alarm range, a range that is separated in distance from the work machine is set as a caution range, and a range that is closer in distance to the work machine than the caution range is set as a warning range.

9. The periphery monitoring device for a work machine according to claim 1,
wherein the display range is smaller on a front side of the work machine than on a rear side of the work machine.

10. The periphery monitoring device for a work machine according to claim 1,
wherein the detector has a fan-shaped horizontal two-dimensional plane as a detection plane, the two-dimensional plane extending in a horizontal direction of the work machine within a range of a predetermined angle from a straight line of a predetermined length extending horizontally rearward to each of both left and right sides of the detector as a center.

11. The periphery monitoring device for a work machine according to claim 10,
wherein the predetermined length is 25 m, and
the predetermined angle is 135°.

12. The periphery monitoring device for a work machine according to claim 10,
wherein the detector has a three-dimensional range as the detection range, the three-dimensional range being obtained by inclining the fan-shaped detection plane upward and downward within a range of an angle of 90 degrees or less around a horizontal axis passing through the detector in a left-right direction.

13. The periphery monitoring device for a work machine according to claim 1,
wherein the detection range is smaller on a front side of the work machine than on a rear side of the work machine.

14. The periphery monitoring device for a work machine according to claim 1,
wherein the detector performs detection by rotating a detection plane parallel to a vertical direction of the work machine, leftward and rightward around a vertical axis.

15. The periphery monitoring device for a work machine according to claim 1, further comprising:
an input unit that sets the display range.

16. The periphery monitoring device for a work machine according to claim 15,
wherein when the display range is not set, the overhead image is displayed based on a result of detection within an entirety of the detection range.

17. The periphery monitoring device for a work machine according to claim 15,
wherein when the display range is set, the overhead image is displayed based on a result of detection within the display range.
